(19) United States
(12) Patent Application Publication
(10) Pub. No.: US 2002/0042882 A1
(43) Pub. Date: Apr. 11, 2002

(54) Computer security system

(76) Inventors: R. Donald Dervan, Lawrenceville, GA (US); Richard Allyn Taylor, Snelville, GA (US)

Correspondence Address: LERNER AND GREENBERG, P.A., POST OFFICE BOX 2480, HOLLYWOOD, FL, 33022-2480, US

(21) Appl. No.: 09/974,927

(22) Filed: Oct. 10, 2001

Related U.S. Application Data
(60) Provisional application No. 60/239,030, filed on Oct. 10, 2000.

(51) Int. Cl. G06F 11/30

(52) U.S. Cl. 713/200

(57) ABSTRACT

A variety of security levels are provided with the novel computer security system, depending on the use and connectivity of the system. On individual computer systems, the primary functions are to control user access to the computer (password, biometric scanning, etc.) and to maintain data security and integrity (embedded encryption and maintaining data and copies encrypted). Computers that are configured into networks utilize not only the features of an individual computer but can be further enhanced by adding communications security. When the communication is effected through the Internet, another level of security is added that allows normal non-encrypted communications with computers or servers that do not utilize the novel security system. Within the novel system there are both software and hardware features that guard against security breaches, depending on the level of security desired.

### BACKGROUND OF THE INVENTION

### FIELD OF THE INVENTION

The invention lies in the computer and communications fields and relates, more specifically, to a computer security system. The security system deals with the overall security and data integrity of modern computer systems. The system, in its various forms, is applicable to individual computers, networked computers, and computer systems which communicate through the Internet.

Computer security systems exist in a wide variety of functional and structural access restrictors. Computer security systems range from simple user identification entry, with or without password, to full service firewalls and biofeature access authorizations, as well as data signal encryption. It is well known, however, that even systems which are considered most secure are subject to unauthorized access or hacker attack. Further improvements in the security features for computer systems are therefore desirable.

### SUMMARY OF THE INVENTION

It is accordingly an object of the invention to provide a computer security system, which overcomes the above-mentioned disadvantages of the heretofore-known devices and methods of this general type and which further enhances the security of computer systems at a relatively low cost and with a relatively minor amount of intrusion into the computer system.

With the above and other objects in view there is provided, in accordance with the invention, a computer security system, comprising:

a terminal security access device (TSAD) connected to a computer and configured to prohibit access to the computer upon detecting an unauthorized access attempt and to maintain data security and integrity on the computer;

the terminal security access device determining access to the computer by checking operations selected from the group consisting of passwords, fingerprint readers, biometric sensors, and electronic surveillance systems;

the terminal security access device maintaining data security by embedding encrypted security codes with the data, by transferring the data in encrypted form at all times, by providing copies of the data exclusively in encrypted form, and by enabling transfer of the data to another computer only if the other computer is equipped with a similar security system.

In accordance with an added feature of the invention, the terminal security access device comprises at least one component having a self-destruct feature, such that when the self-destruct feature is triggered, access to the computer is denied.

In accordance with an additional feature of the invention, the computer is configured in one or more networks and the system further comprises an added communications security system.

In accordance with an additional feature of the invention, the communications security system is a multi-level process of transferring data from one location to another electronically within the network, a first level utilizing the encrypted data and a second level formed with security-enhanced modems.

In accordance with an additional feature of the invention, security-enhanced modems are provided with at least one component having a self-destruct feature.

With the above and other objects in view there is also provided, in accordance with the invention, a method of providing access security to a computer system, which comprises the following method steps:

providing a computer access security system (CASS) enabled to allow or deny access to a computer; initializing the computer access security system upon an initial system startup, by assigning personal access code numbers (ACNs) for each administrator of the computer access security system, assigning an initial terminal security code, and allocating limited access storage space for receiving audit and access data;

upon receiving a request for administrator access the computer system, prompting for user input of the personal access code number and subsequently verifying the personal access code number;

storing in the access storage space all successful and unsuccessful access attempts and accesses to the computer system; and

subsequent to the initial setup of the computer system, continuing with a sequence of operations starting with computer user login.

In accordance with another mode of the inventive process, with a computer security access device periodically transmits to a terminal security access device a new randomly generated terminal identification number (TIDN).

In accordance with a concomitant mode of the invention, the terminal identification number (TIDN) is always transmitted in encrypted form.

In further summary, when the novel security system is used on individual computer systems, the primary functions are to control user access to the computer and to maintain data security and integrity. Access control is maintained by the use of passwords, fingerprint readers or other biometric sensors, and/or other electronic security systems. Data security is maintained by utilizing embedded encrypted security codes. The data are in their encrypted form at all times, and can only be observed on a terminal or in printed copy. Copies of the data are always in encrypted form and can only be read by or into another computer with the enhanced security system.

Computers that are configured into networks either LANs, WANs or in a combination of networks can utilize not only the features of an individual computer but can be further enhanced by adding communications security. The communications security is a multi-level method of transferring data from one location to another electronically within the confines of the network. The first level utilizes encrypted data, followed by a second level of security enhanced modems. The modems are equipped to provide communication with either hardwired systems or dial up systems using conventional telephone equipment. Within the modems there are provided a number of automatic procedural features that will prevent monitoring or tampering with the equipment.

When the communication is effected through the Internet, another level of security is added that allows normal non-encrypted communications with computers or servers that do not utilize the novel security system. This however does pose the problem of intentional tampering, i.e., the injection of viruses or worms, or their various pseudonyms. Recognizing this possibility, we have added a greatly enhanced virus detector to prevent this potential problem.

Within the novel system there are both software and hardware features that can be used depending on the level of security desired. The system can thus be adapted to any level of security desired by the user.

Other features which are considered as characteristic for the invention are set forth in the appended claims.

Although the invention is illustrated and described herein as embodied in a computer security system, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

FIG. 1 is a diagrammatic overview of the computer access security system (CASS) according to the invention;

FIG. 2 is a schematic block diagram of a terminal security access device (TSAD) according to the invention;

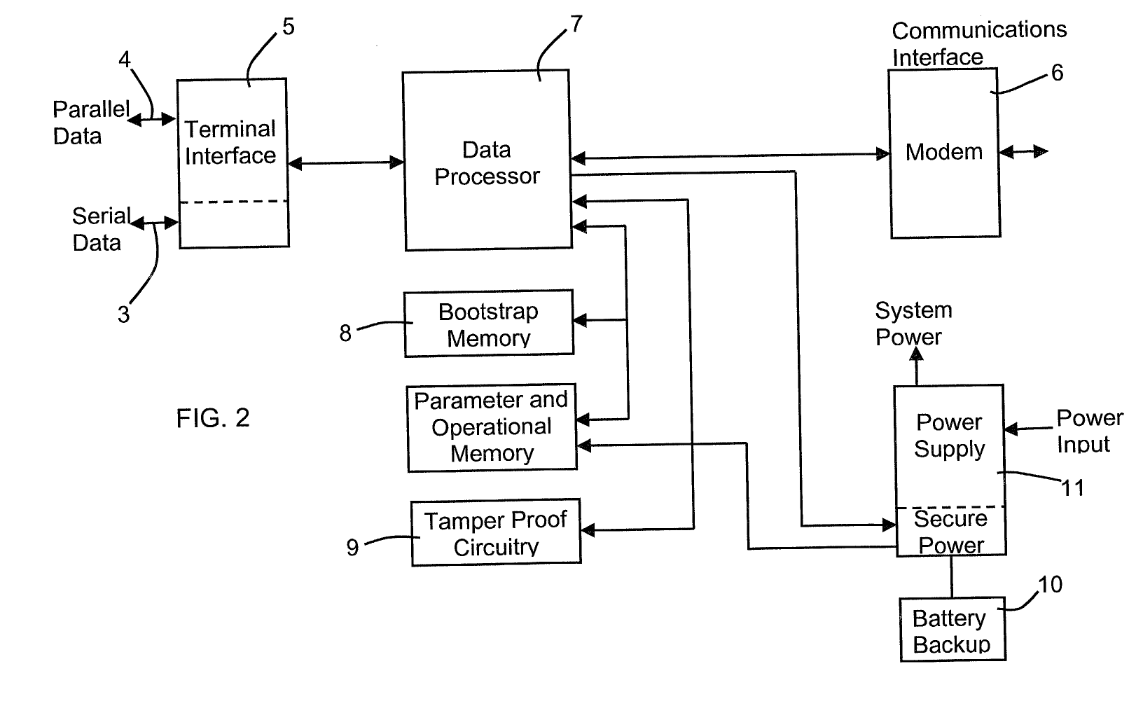

FIG. 3 is a schematic block diagram of a computer security access device (CSAD) according to the invention;

FIG. 4 is a flowchart illustrating the connect procedure in the computer access system according to the invention; and

FIG. 5 is a flowchart illustrating an initialization and logon procedure with security check.

### DESCRIPTION OF THE PREFERRED EMBODIMENTS

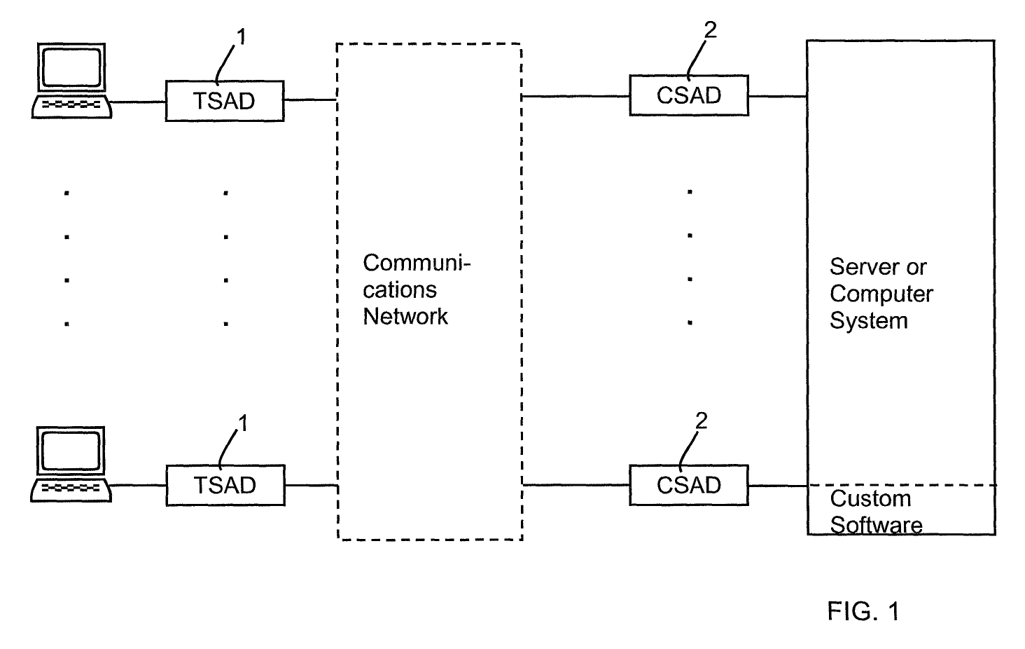

Referring now to the figures of the drawing in detail and first, particularly, to FIG. 1 thereof, there is seen a diagrammatic overview of the novel computer access security system (CASS). The system consists of software and hardware to control the access to computer systems. The hardware portion of the security system is comprised of a terminal security access device (TSAD) 1 and a computer security access device (CSAD) 2. These devices when associated with either a hard-wired system or a dial-up telephone system allow secure communications between terminals and computers or computer to computer systems. Custom software installed within the computer(s) work with the hardware to provide the enhanced security features.

A standard method of encryption is used within the CASS. The encryption system used is of a special design incorporating both software and hardware to ensure the integrity of all data and special communications processed through the CASS.

The TSAD 1 can either be an internally or externally mounted device and comprises the following:

A serial link 3 to connect to a terminal or remote computer. The serial link 3 can take any of the conventional forms, namely, either RS-232, RS-422, RS-485, USB, or others as required. Other versions are available that will support parallel formats and direct PC plug-in. A parallel input 4 is indicated into the terminal interface 5.

Coding devices to provide the security access code. The coding device while providing the security access code is further enhanced by modifying the transmitted code each time access is gained, as well as being continually modified on a random basis. The modified code is tracked in the CSAD 2 to maintain the ability to connect to the system.

A modem 6 provides access to the various communications schemes, i.e., public telephone systems, hard-wired systems, etc. The proprietary modem embedded into the TSAD provides the necessary interface to allow connection to the desired communications scheme. This can be a POTS, DSL, Ethernet or other types of connection.

An internal controller 7 monitors and controls all of the aspects of the TSAD. The controller 7, which is in the form of a microprocessor, controls all of the operating functions of the TSAD. It also controls the communications and encryption functions. All of the operational software is downloaded into the controller 7 during the initial set-up of the system and is stored in a memory 8 that is powered by a backup battery.

Tamper proof security systems 9 prevent unauthorized access to the internal codes and operating system. The method used to insure tamper proof access to the TSAD is both electronic and mechanical in nature. If any attempt is made to circumvent the interlock system, power will be removed from the TSAD memory rendering the unit useless. The TSAD can be used again when properly configured into a CASS. Whenever an attempt is made to either remove the TSAD or gain unauthorized access to the TSAD, the electrical power to the program memory will be automatically removed and all of the operating parameters will be lost until such time as the TSAD is reconnected under authorized circumstances. This is generally referred to as a self-destruct feature.

The method of detecting an attempt to tamper with the TSAD is by using one or more of the following sensory items, which include: interlocked printed circuit board pins, mechanical switches, interlocked input/output I/O connector pins, and similar means that will be determined in the future. When the power to the memory is removed, it is also shorted out to zero volts within a few nano-seconds thereby rendering the memory completely inoperable. Only when all of the tamper proof elements have been reconnected will the memory again have power available to it so that it can be re-enabled under authorized circumstances. While anyone can re-enable the power, only when authorized communications to the CSAD has been re-established will the memory be re-programmed with the necessary parameters for normal usage.

The TSAD further includes a power and backup battery system 10. The normal power for the TSAD is provided by a wall mounted power supply package 11 with internal batteries for powering the memory and short term operation.

The CSAD 2 may be configured in a variety of styles depending upon the number of lines and the method of communication.

A single stand-alone CSAD can be used in a small system configuration. A multiple CSAD with a common mounting configuration enhances the wiring and eases the space use within a computer room.

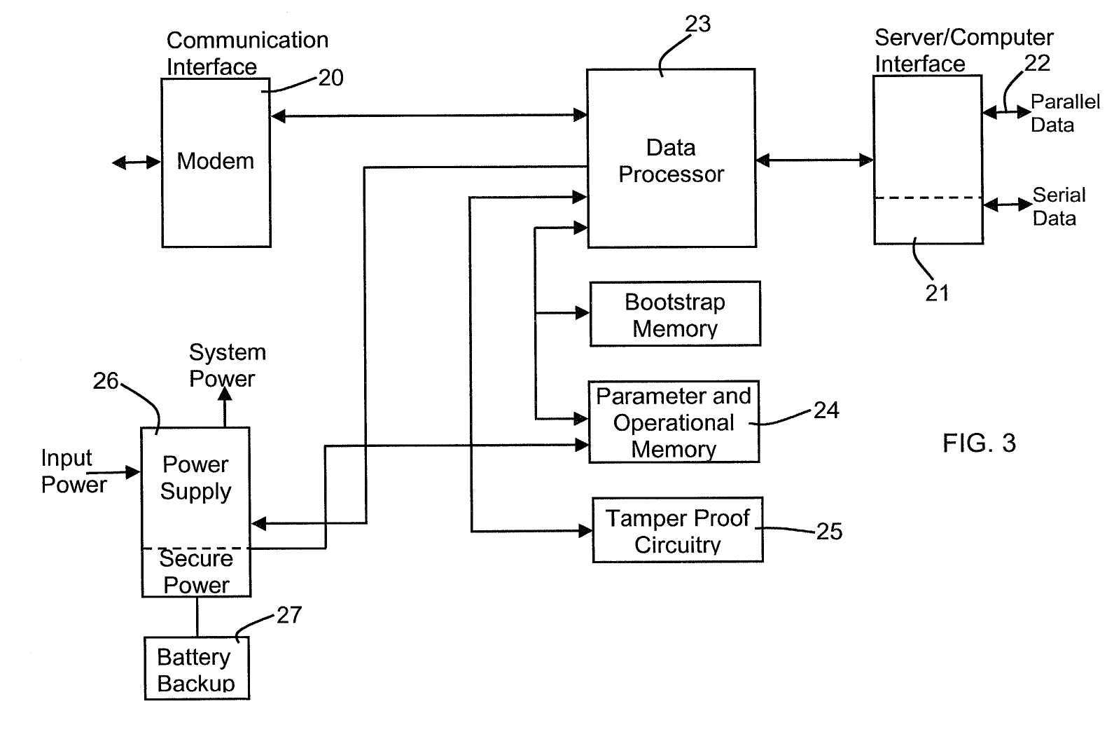

Referring now to FIG. 3, the computer security access device CSAD 2 includes the following elements:

A modem 20 provides access to the various communications schemes, i.e. public telephone systems, hard-wired systems, etc. The proprietary modem 20 embedded into the CSAD 2 provides the necessary interface to allow connection to the desired communications scheme. This can be a POTS, DSL, Ethernet or other types of connection.

In multiple CSAD systems, a multiplexer is provided to reduce the system wiring. The multiplexer combines the data streams of many CSADs into a high speed data format that communicates to a high speed port on a server or large scale computer system.

All necessary serial links 21 are provided to control the communications between the CSAD(s) and the computer system. The serial link can be either RS-232, RS-422, RS-485, USB, or others as required. Parallel communication format may be available as well. The parallel format interface is indicated at 22.

Coding devices verify the security access code. The coding device while providing the security access code is further enhanced by modifying the transmitted code each time access is gained, as well as being continually modified on a random basis. The modified code is tracked in the CSAD 2 to maintain the ability to connect to the system.

An internal controller 23 monitors and controls all of the aspects of the CSAD 2. The controller 23, here a microprocessor, controls all of the operating functions of the CSAD 2 and controls the communications and encryption functions. All of the operational software is downloaded into the controller during the initial set-up of the system and is stored in a memory 24 that is powered by a backup battery 25.

Tamper proof security circuitry 25 prevent unauthorized access to the internal codes and operating system. The method used to ensure tamper-proof access to the CSAD 2 is both electronic and mechanical in nature. Similarly to the above description of the TSAD 1, the CSAD 2 is also provided with one or more self-destruct features, that is, if any attempt is made to circumvent the interlock system, power will be removed from the CSAD memory rendering the unit useless. The CSAD 2 can be used again when properly configured into a CASS. Whenever an attempt is made to either remove the CSAD 2 or gain access to the CSAD 2, the electrical power to the program memory 24 will be automatically removed and all of the operating parameters will be lost until such time as the CSAD 2 is reconnected under authorized circumstances. The method of detecting an attempt to tamper with the CSAD is by using one or more of the following sensory items. These items are as follows, interlocked printed circuit board pins, mechanical switches, interlocked Input/Output connector pins and other means that will be determined in the future. When the power to the memory is removed, it is also shorted out to zero volts within a few nano-seconds thereby rendering the memory completely inoperable. Only when all of the tamper proof elements have been reconnected will the memory again have power available to it so that it can be re-enabled under authorized circumstances. While anyone can re-enable the power, only when authorized communications to the CASS has been re-established will the memory be re-programmed with the necessary parameters for normal usage.

Power for the CSAD 2 is provided by a power and backup battery system. The normal power for a single CSAD is provided by a wall mounted power supply package 26 with internal batteries 27 for powering the memory and short term operation, for systems using many CSADs a power supply is provided to each of the common mounting frames.

Software supplied with the CASS consists of the following modules.

All necessary I/O drivers.

Control and coding software for the TSAD.

Control and coding software for the CSAD.

System encryption control software.

System operation and monitoring software.

The computer access security system CASS functions as follows: to begin with, during the initial system startup, a number of operational features must be set up to provide the features of the enhanced security system.

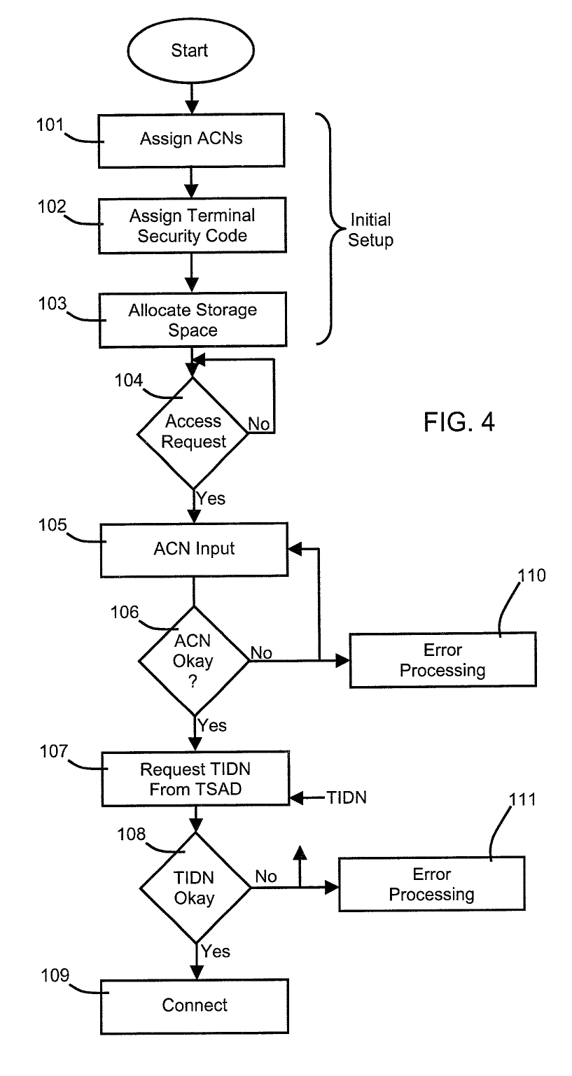

With reference to FIG. 4, personal access code numbers (ACNs) for each user of the system must be assigned in a step 101. This code is to provide access to the TSAD and CSAD security features and has nothing to do with the computer system and file access.

An initial terminal security code must be assigned at system startup in step 102. This allows for the initial communication to the system. Once the initial communication has been established, a new security code will be periodically provided to the TSAD.

A limited access storage space must be allocated in step 103. The space contains the audit and access data. These data provided by the CSAD will be recorded on all accesses whether successful or not.

After the initial setup of the communications system and computer system, which includes the steps 101, 102, and 103, the following sequence of operations will commence.

When a request is made at 104 to access the computer system, the CSAD requests the ACN from the user at 105. When the user supplies the ACN, it is verified by the CSAD in 106. The CSAD at this time analysis the ACN. This analysis is to verify that the ACN is correct and will also aid in the detection and prevention of unauthorized use.

Once verification of the ACN has been made, the CSAD requests from the TSAD the terminal identification number (TIDN) at 107. The TSAD responds with its encrypted TIDN that is verified through an analysis algorithm by the CSAD at 108. When verification has been completed, the terminal is connected to the computer system at 109. During this verification process, if it is determined that an attempt is being made to bypass the security system, there are a number of features built into the software system that will control and record critical data. These features will aid in future attempts to thwart the security features as well as provide valuable data to locate individuals trying to enter the system. The error processing is diagrammatically indicated at boxes 110 and 111.

During the foregoing initialization and access processing, all of the activity related to the verification process is logged into the audit and access data file. In a preferred embodiment of the invention, the novel security system also provides a review log for upper management or corporate/government security for the purpose of detecting and providing audit trails of employees using the computer system, showing what levels they entered, unauthorized attempts to access levels not cleared for, whether data was altered or a hard copy taken.

The CSAD transmits to the TSAD on a periodic basis, a new randomly generated TIDN. The process of transmitting this new TIDN is encrypted. This renders the detection of the TIDN by illegal monitoring virtually impossible.

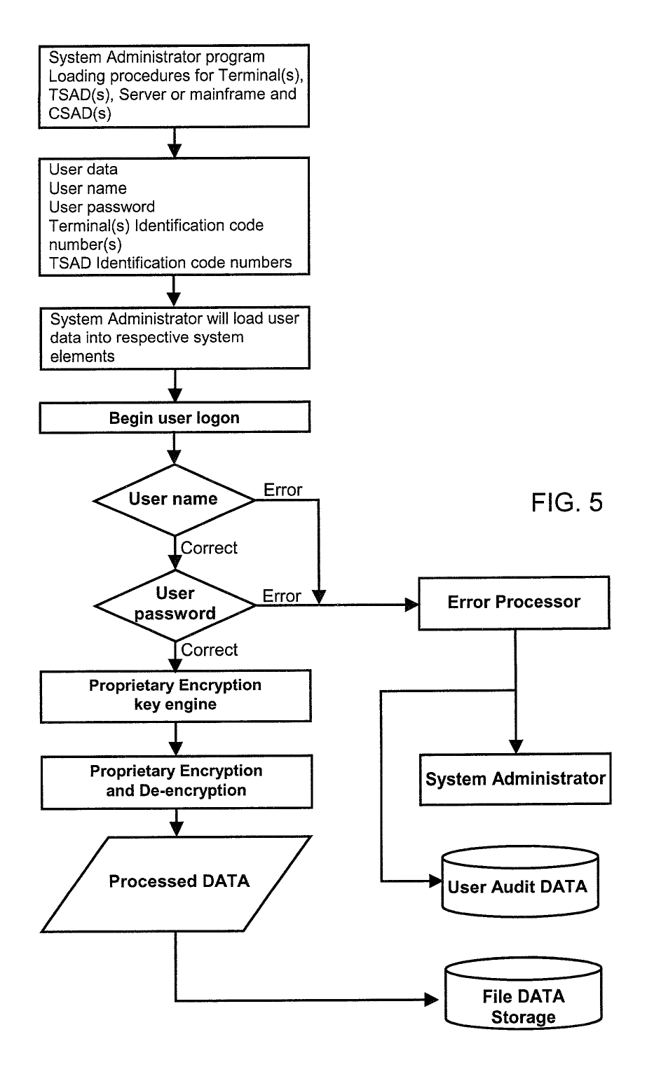

A slightly altered and expanded initialization and logon procedure with security check is illustrated in the flowchart of FIG. 5. The processing sequence of FIG. 5 applies when the system is initialized and/or when additional users are added.

First, the system administrator must load the programs supplied with the novel security system package onto the terminals, the server or mainframe, the TSADs and the CSADs.

Each authorized user must supply to, or will be assigned by, the system administrator the following information:

User name

User password (for system logon identification). The password requires periodic changing.

Terminal and TSADs identification number which the user is authorized to use.

The system administrator then enables the TSADs, the server or mainframe, and the CSADs associated with the computer system to allow communications with the authorized user.

Once the system administrator has the system prepared for the user, the user may request a system logon. During the logon procedure, the user will be requested to enter the user name. After the user name has been accepted, a request for the initial user password is made. If the system accepts the user password, the system will establish a communications link with the user.

During the initializing procedure, an initial encryption key is established. The encryption key is subsequently changed occasionally to ensure complete security of all transmitted data.

If an attempt is detected to log on either in error or by an unauthorized user either during the initial or subsequent log on, the system enters a software trap. The trap enables a variety of responses which may be designed in accordance with the specific circumstances and the specific application of the system. One of these responses alerts the system administrator of the action causing the alert and attempt to identify the individual attempting to log on.

Having provided a detailed description of the physical embodiments of our invention, we now provide a further overview with definitions and explanations applicable to the novel system according to our invention.

Physical Security

The term physical security refers to the maintaining of the computers' communications lines and their software in a state of complete protection.

The building or physical plant within which the computer system is located must be secure to the level of economic practicality. It is obviously not necessary to have guards around a home when the data being secured is only personal phone lists and recipes. On the other hand it would not be advisable to have open buildings and rooms, that would allow any person to roam around, if the data being handled is of a nature that could jeopardize the products or services of a company or Governmental agency.

The simplest of physical security would be nothing but door locks of the standard key type. These can be easily defeated or picked and are really designed to keep out honest people.

The next level of door security would be combination locks of either the push button type or the rotary tumbler type. As with most types of security these depend on the controlled distribution of the combination.

The next level of door security would be the use of cards readers these can be very simple punched holes types to magnetic stripe styles. These can be further augmented with the use of computerized entry, controls which all check for individual levels of entry security.

Guards, gate houses, multiple internal room entry, Video monitors, fingerprint sensors, iris scanners and many other forms of entry control can be employed when the cost of such measures is justified by the level of security needed.

The source of electrical power to operate the computer(s) or system must be maintained at a level to continue operation until either an orderly shutdown can occur or an emergency source of power can come online to maintain continuous operation.

Do nothing and rely only on the utility company to provide power for the system. Use a UPS to provide a short term source of power. Augment the UPS with a motor generator system. Use dual utility power feeds. Utilize a combination of several or all of the above mentioned methods.

The hardware of the overall system must be secured in such a way as to prevent the removal of the components. The less secure the facility is the greater the need for safe keeping of the computer hardware. The prevention of the removal of hardware can be attempted with the use of bolting, tying or other physical restraints.

The software associated with the system must be kept in a secure area that will not allow the removal or copying of the software. There are in essence two classes of software, there are programs consisting of operating systems and applications programs, and then there is the data itself which is collected processed or by other means assembled into files. File cabinets (preferably locked), safes, separate controlled access areas (off site possibly) and many other methods can be used to limit the availability. Data files should be backed up on a regular basis and placed in areas that are not only secure from access but secure from fires or other means of destruction.

General Security

This term refers to the operation of the computer(s) or the system. Power integrity, similarly to above, covers the topics associated with the maintaining of electrical power to the system.

System integrity refers to the maintaining of the system as an operation entity. Hardware in the form of computers, servers, interconnections, modems, disks and tape drives or what ever is required in the complete installation must be regularly monitored, tested, serviced and cleaned. Regular checking of system performance with diagnostic software tools will assure the proper operation of the processor and memory components. The use of the diagnostic tool will prevent many random errors. The controlling of the ambient temperature within the operating range of the hardware is a requirement that must be adhered to. Failure of this simple requirement will result in both random failures and continuous failures. Permanent damage of the equipment is unlikely with the exception of magnetic particle systems such as disk drives and tape drives.

Programs and data should be regularly backed up. A regular schedule of backups is an absolute necessity to maintain the integrity of the software and data associated with it. A typical schedule of backups might be as follows. A complete system backup once per month, a complete data backup once per week and a daily backup of data files that have changed. Backups should be kept in a secure manner. Consideration should be made that may include fireproof safes, offsite secure storage or multiple copies in different locations. Under all conditions, physical security of the backup files needs to be considered.

Removable media can be in the form of tapes, discs or complete swappable drives. Any time that removable media exist, extreme care must be taken for the security of the data. Careful handling must also be considered for the integrity of the data. A common method of controlling access to removable storage is to secure the media in a fireproof safe.

Various features must be taken into account with regard to the management of the computer system. Physical management of the system involves complete control of the equipment, facility and security. Software management is the control and distribution of software and upgrades when they are available. This control is required to allow each user within a system environment to maintain data integrity across the system and network. Programming management involves proper documentation and direction of any and all customized or in house modified software.

Data Security and Integrity

Passwords are probably the most interesting single item in security control. Most computer users use passwords that are easy to remember such as nicknames, family dates such as birthdays or other such simple items that would be quite easy for an intruder to obtain. This of course does not lend itself to high levels of security. Passwords should contain alpha characters, numeric characters and punctuation. Passwords should also be changed on a regular basis. Unfortunately even with these precautions passwords can always be circumvented because there is a common location of all passwords which is under the control of the system supervisor. Other forms of password protection do not necessarily constitute typed entry. These other forms can be fingerprint, handprint, iris patterns or other physical attributes of the individual. Since these forms of identification are usually digitized data, encoding of this data needs to be done so that a tap on communications lines can not obtain real data. The encoding or scrambling algorithm will also need to be modified periodically to decrease the possibility of clandestine decoding of data.

The prevention of data monitoring to obtain passwords and other pertinent data can be made more difficult by the use of data encryption. The algorithm for encrypting the data can be a variety of mathematical manipulations there are some standards for encryption at this time. The key word for data encryption should be changed on a random and frequent basis, this will frustrate anyone who may try to decode the data if it is monitored.

When a computer terminal is used a visual representation of data is present, this information can be viewed by anyone who cares to look at the screen. There should be care taken in the placement of the monitor so that people can not inadvertently view the data. Whenever the person using the monitor stops or leaves, care should be taken to turn off the screen. A time function can also be implemented to turn off the screen. To resume operation of the monitor screen a password or sequence of keystrokes should be incorporated to prevent unauthorized users from observing the screen and data on it. Generally when a monitor is used there is commonly a keyboard and or a mouse associated with it. These items need to be hard wired to the monitor or computer associated with them, the use of IR (infrared) or RF (radio frequency) links should never be used in a high security system. The signals from these links can be easily monitored and are not generally encrypted.

File handling refers to controlling the commonality of files and their locations. In high security systems greater attention must be used in the handling of files. When multiple users have access to files there has to be a system of file upgrading to prevent the work of one person affecting the changes caused by another authorized person. This generally involves the use of checks of modifications and the use of common file locations in either a master computer or file server. When files are deleted a method of complete removal must be incorporated. In the regular file deletion, only the first character of the file name is changed and references to the file location. This allows recovery and viewing of the files if desired, but this also lends itself to unauthorized file recovery and copying. When files are completely removed or deleted, the standard way of doing this is to completely write over the data area to obliterate the actual data.

Viruses and a variation of them called worms have been in the news quite a bit lately. They can be extremely disastrous if allowed to enter a computer system. They can be mundane such as occasionally putting a message on the screen. Others can be very dangerous in that they can gain control of the operating system and delete files both data files and program files. A recent variation of these viruses can also propagate themselves by re-sending the virus to any or all of the addresses located in personal address books maintained on the computer. There are a number of commercial virus scanning software packages available now, these packages are quite good at catching the viruses and warning the operator that possible corrupted data is present. Unfortunately, the individuals that write and distribute these viruses are also aware of the software suppliers efforts, and are always writing new versions that attempt to circumvent the virus checkers. Many of the newer viruses utilize the Internet communications system to obtain access to your computer. Because of this latest method of attack, the suppliers of Internet software are actively working on methods of preventing viruses from passing through there systems.

As noted above, data encryption is the process by which data are combined in a mathematical algorithm that renders the data indecipherable without knowledge of the encryption algorithm. The algorithm is determined by a “key”, this key is identical in the encryption and decryption of the data. The key determines the functionality by which the data are encrypted or scrambled, therefore, the key itself needs to be protected or held secure. The common way to do this is to periodically change the key by a mutually agreed upon method.

One method that has been used is to have a book with a series of dates or times and the key to be changed at these times, this works well if the books are secured. Another method is to transmit the new key periodically over the same link as the encrypted data. To do this another method of encrypting the key has to be conveyed as well.

Data compression is the process of removing unnecessary information that is not necessary to convey the complete and accurate message. To do this, the process or algorithm must not only remove unneeded information but also must provide to the receiving end the information required to reconstruct the compressed data. Data compression is used in two principal ways, one is to reduce the space required to store information and the other is to reduce the length or size of files to permit more rapid transmission of data. Since both ends of the communications link must have a similar method of compression and decompression, this adds a very small level of security.

As this system pertains to multi-user systems, multi-user data integrity must be ensured at all times. In a multi-user environment where more than one authorized person may have access to the same files, a potential to corrupt the files exists. As an example, if two or more people have accessed a common file and each are making changes to the file, when the files are stored by the individuals there will be differences between the files. There are some automatic methods to allow the resolution of this conflict, and in complex cases there may have to be human intervention to resolve the conflict.

Communications Security

As discussed above, the use of passwords or physical attributes is an absolute requirement when security of communications is required. Because of the abilities that have been developed to listen to conversations (either verbal or data), it has become increasingly difficult to obtain secure transmission of information. To aid in the security, a password protection scheme has been developed by us to assist in the prevention of unauthorized users gaining access to the system or data. This password protection scheme utilizes random timing and scrambling techniques to prevent the copying of the passwords.

The communication includes computer to computer direct or modem communication. When computers are connected in a directly wired manner, the most common type of entry into the data files or system files is by an individual obtaining access to one of the computers (usually at times when authorized users are not around). Once physical access has been obtained it is usually not difficult to gain access to the data stored in the computer system. This is normally done by trying (if the person does not know) a series of password combinations until an acceptable password has been entered. A common way of doing this is through the use of an automated number sequence device that tries combinations until access has been gained. Computer systems that are connected through direct modem connections (either direct-wired or dial-up) another method of access has been opened up to an unauthorized person. This access is through the use of “taps” on the wiring either inside or outside of a building. Once access has been gained into the wiring, again internal access to the data files can be made with the use of a password scanner mentioned above.

As noted above with reference to blocks 110 and 111 in FIG. 4, error handling includes analyzing attempts to bypass password security. The system assists not only in the prevention of unauthorized users gaining access to the system or data, but will in most instances also identify and compromise the unauthorized user.

LANs (Local Area Networks) and WANs (Wide Area Networks) are extensions of direct connected computer to computer networks. These types of systems or networks allow communications on a very broad scale which will again allow other means of compromising security. LANs and WANs are commonly connected via hardwire to so-called hubs. These hubs in turn are connected usually with local servers that then connect to the main system either with hard wires or other means. The other means are often dedicated modem systems or dial up modem systems or Internet systems. All of these communications systems utilize packets of data to transfer information. Each of the packets contains information as to the source destination, data and check characters. This packetized data can then be routed to its proper location. The packetized data can be made available to skilled people by taping into the communications lines and can be selectively decoded.

Servers have been developed to provide a common system location to perform various functions. In most large systems, a printer server is used to process all print functions. This print server will accept data to be printed from all locations and distribute the data to be printed to the proper output device. Devices such as Laser printers, Ink Jet printers and Document printers that can print in color as well as collate and bind. Often telephone lines are connected to the print server so that telefaxes can be sent through the system.

A file server is another type of server that is connected to computer systems. Often in large systems, multiple file servers are used so that multiple copies of the same information can be used as backup or file comparison. In many systems, usually smaller ones the server(s) are part of the system computer(s) themselves. This often will present problems when sharing data if one or more of the computers fail.

The Internet is becoming so pervasive in our lives that it has become one of the fastest growing fields of communications. Data that once would require specialized systems to communicate have become commonplace. The Mail system is losing a great deal of activity because of Email. Retail stores in the very near future will be greatly impacted by the people making purchases on-line. Banks are now connected via the Internet to each other and to customers.

The Internet is not a dedicated system built to perform the functions that are required, but it is the same system used to provide voice (telephone), data or video. This system works with exactly the same equipment that has in some cases been there for 50 or more years. This system which is being upgraded daily is the backbone of all of our modem communications. Because of the variety of wire, satellite, microwave and optical connections used in this system, as well as the redundancy of the links it is not possible to predict the route that the data will travel. As there is no direct linkage from one destination to another, there has to be imbedded within the message itself, all of the information required that will allow tracking of the data. The data itself is packetized at the source and de-packetized at the destination. A message may contain many packets of data that may travel over many different routes or links, only to arrive at the destination in a random order. The many layers of hardware and software that make the Internet practical have the ability to reorder these packets into a meaningful data stream.

While this apparently chaotic structure of data transmission seems strange, it does provide some very useful attributes. If one route is not working, the system will provide on a totally automatic basis another route for the data. Also many methods of tapping into data will not work because the routing of data is not known, therefor a level of security does exist that prevents the general population from obtaining meaningful data. However there are specific methods of tapping that can, to the educated individual, allow data to be obtained.

In view of the above disclosure it is clear that the novel system which is subject to this description of the following claims provides for methods of dealing with data handled over the Internet as well as any other communications connection. The invention described herein is easily packaged with many security features into a package that allows secure data to be carried without the concern of its security or integrity.

We claim:

1. A computer security system, comprising:
a terminal security access device connected to a computer and configured to prohibit access to the computer upon detecting an unauthorized access attempt and to maintain data security and integrity on the computer;
said terminal security access device determining access to the computer by checking operations selected from the group consisting of passwords, fingerprint readers, biometric sensors, and electronic surveillance systems;
said terminal security access device maintaining data security by embedding encrypted security codes with the data, by transferring the data in encrypted form at all times, by providing copies of the data exclusively in encrypted form, and by enabling transfer of the data to another computer only if the other computer is equipped with a similar security system.

2. The computer security system according to claim 1, wherein said terminal security access device comprises at least one component having a self-destruct feature, such that when the self-destruct feature is triggered, access to the computer is denied.

3. The computer security system according to claim 1, wherein the computer is configured in one or more networks and the system further comprises an added communications security system.

4. The computer security system according to claim 3, wherein said communications security system is a multi-level process of transferring data from one location to another electronically within the network, a first level utilizing the encrypted data and a second level formed with security-enhanced modems.

5. The computer security system according to claim 4, wherein said security-enhanced modems are provided with at least one component having a self-destruct feature.

6. A method of providing access security to a computer system, which comprises the following method steps:
providing a computer access security system enabled to allow or deny access to a computer;
initializing the computer access security system upon an initial system startup, by assigning personal access code numbers for each administrator of the computer access security system, assigning an initial terminal security code, and allocating limited access storage space for receiving audit and access data;
upon receiving a request for administrator access the computer system, prompting for user input of the personal access code number and subsequently verifying the personal access code number;
storing in the access storage space all successful and unsuccessful access attempts and accesses to the computer system; and
subsequent to the initial setup of the computer system, continuing with a sequence of operations starting with computer user login.

7. The method according to claim 6, which further comprises periodically transmitting with a computer security access device to a terminal security access device a new randomly generated terminal identification number.

8. The method according to claim 7, which comprises transmitting the terminal identification number in encrypted form.
